(19) United States
(12) Patent Application Publication
(10) Pub. No.: US 2003/0104826 A1
(43) Pub. Date: Jun. 5, 2003

(54) External connection device with bluetooth function in multiple modes

(76) Inventors: Ten-Long Deng, Taipei (TW); James Yeh, Taipei (TW)

Correspondence Address: BIRCH STEWART KOLASCH & BIRCH, PO BOX 747, FALLS CHURCH, VA, 22040-0747, US

(21) Appl. No.: 10/303,858

(22) Filed: Nov. 26, 2002

(30) Foreign Application Priority Data
Dec. 4, 2001 (TW) 090221101

(51) Int. Cl. H04Q 7/00

(52) U.S. Cl. 455/462

(57) ABSTRACT

An external connection apparatus with the Bluetooth function includes a host controller interface device, a RFCOMM transmission device, a port emulated body, and a switching device. If the host side has the Bluetooth driving program, the host controller interface device can pack the received digital data into an HCI packet and export the packet to the host side via the switching device. Next, the Bluetooth driving program at the host side can be executed to process the subsequent data. On the contrary, if the host side does not have the Bluetooth driving program, then the HCI packet transmitted from the host controller interface device will be first processed to have the format of the common sharing port (COM port) by the RFCOMM transmission device and the port emulate body. Then, it is exported from the switching device to the host side and is processed by the application software, which can support the format of the COM port.

This application incorporates by reference of Taiwan application Serial No. 090221101, filed Dec. 4, 2001.

### BACKGROUND OF THE INVENTION

1. Field of the Invention:

This invention relates to an external connection apparatus, and more particularly, to an external connection apparatus with the Bluetooth function.

2. Description of Related Art:

In the early stages of developing the notebook type of computer, the experts had already been expecting that the wireless manner of transmitting data would become mainstream in the future. However, year after year, due to various factors, such as fabrication cost and design complexity, this expectation still has not materialized fully. After the Bluetooth technology has been introduced, experts believe that the computer industry will enter a new technology generation in wireless communications. The Bluetooth technology is a wireless technology with low power consumption. The transmission region is about 10 meters and it uses the bandwidth of 2.4 GHz of the ISM band, which is commonly used in the global communication.

Now referring to FIG. 1, it is a drawing, schematically illustrating the architecture of Bluetooth. A physical bus hardware 130 is used to connect the Bluetooth host 110 and the Bluetooth hardware 120 in cascade, wherein the structure of the Bluetooth hardware 120 includes a baseband controller 121, a link manager (LM) firmware 123, and a host controller interface (HCI) firmware 125. When the data is under transmission, the host controller interface firmware 125 will encode all of the received digital data into a format of HCI packet, and the HCI packet is further fed into the Bluetooth host 110 via the connection of a physical bus firmware 135. After the HCI packet has been sequentially processed by a physical bus driving program 113, the HCI driving program 115, and the other driving program 117 in high level, the various functions under the Bluetooth system can be performed. In the Bluetooth system, the situation for transmitting data by the point to point manner is shown in FIG. 2.

For the current status, the applications of the Bluetooth system are not common. For this reason, some inconvenient situations may occur while the data is being transmitted. Taking the notebook computer as an example, the notebook computer A of the user A has been implemented with the Bluetooth function. However, the notebook computer B of the user B does not include the Bluetooth function. It is then impossible to use the Bluetooth function to transmit the data when the notebook computer A of the user A intends to transmit data to the notebook computer B of the user B. In this situation, some people may suggest that the Bluetooth system also has an extension card, such as the PCMCIA card with the Bluetooth function, available for use in computer B. It can be done by simply installing the Bluetooth driving program into the notebook computer B and plugging in the Bluetooth extension card. Although this solution would suitable, not all users would take the extra steps required to install the driving program, which is not considered as a strongly needed program. Even if the user is willing to install the driving program, the current notebook computer may still be missing in the optical disc drive or the soft disk drive. This causes that the driving program cannot be installed. In this case, it is certain that the connection would be incapable of transmitting data with the Bluetooth technology. Furthermore, the installation of the driving program is time-consuming and cannot be like the devices of plug and play. Thus, the inconvenience for the user is great.

### SUMMARY OF THE INVENTION

It is therefore an objective of the present invention to provide a Bluetooth device not by a built-in design, but by an external connection apparatus with the Bluetooth function in multiple operation modes, so that the user is not required to install the driving program in order to use the Bluetooth function. The external connection apparatus with the Bluetooth function in multiple operation modes of the present invention can switch to the proper data transmission path, according to whether or not the Bluetooth driving program is installed.

In accordance with the foregoing and other objectives of the present invention, the invention provides an external connection apparatus with the Bluetooth function in multiple operation modes, wherein the said apparatus includes a host controller interface device, a RFCOMM transmission device, a port emulation entity, and a switching device. If the host side has the Bluetooth driving program, the host controller interface device can pack the received digital data into an HCI packet and export the packet to the host side by the switching device. Then, the Bluetooth driving program on the host side can be executed to process the subsequent data. On the contrary, if the host side does not have the Bluetooth driving program, then the HCI packet transmitted from the host controller interface device will first be processed to have the format of the common sharing port (COM port) by the RFCOMM transmission device (that is an emulating device for converting a protocol of the Bluetooth communication into a serial port protocol) and the port emulation entity. Afterward, it is exported from the switching device to the host side and is processed by the application software, such as the network neighboring or telnet, which can support the format of the COM port. It is noted that the switching device can automatically switch the data transmission manner to the proper one, according to whether or not the host side has the Bluetooth driving program. In this manner, once the external connection apparatus with Bluetooth function is connected, all of the data can be processed for transmitting data in the wireless way, whether or not the host side has the Bluetooth driving program.

### BRIEF DESCRIPTION OF DRAWINGS

The invention can be more fully understood by reading the following detailed description of the preferred embodiments, with reference made to the accompanying drawings, wherein:

FIG. 1 is a drawing, schematically illustrating an architecture of the Bluetooth system;

FIG. 2 is a drawing, schematically illustrating the data transmission situation by the point to point method;

FIG. 3 is a drawing, schematically illustrating the situation for the RFCOMM in the Bluetooth system to emulate the port of RS232; and

FIG. 4 is a block diagram, schematically illustrating an external connection apparatus with the Bluetooth function capable of multiple operation modes, according to one embodiment of the present invention.

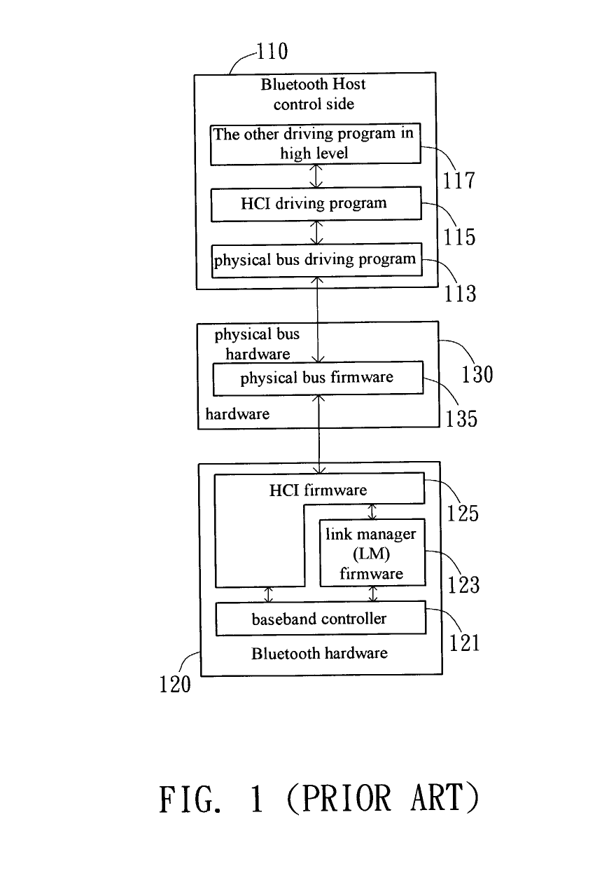

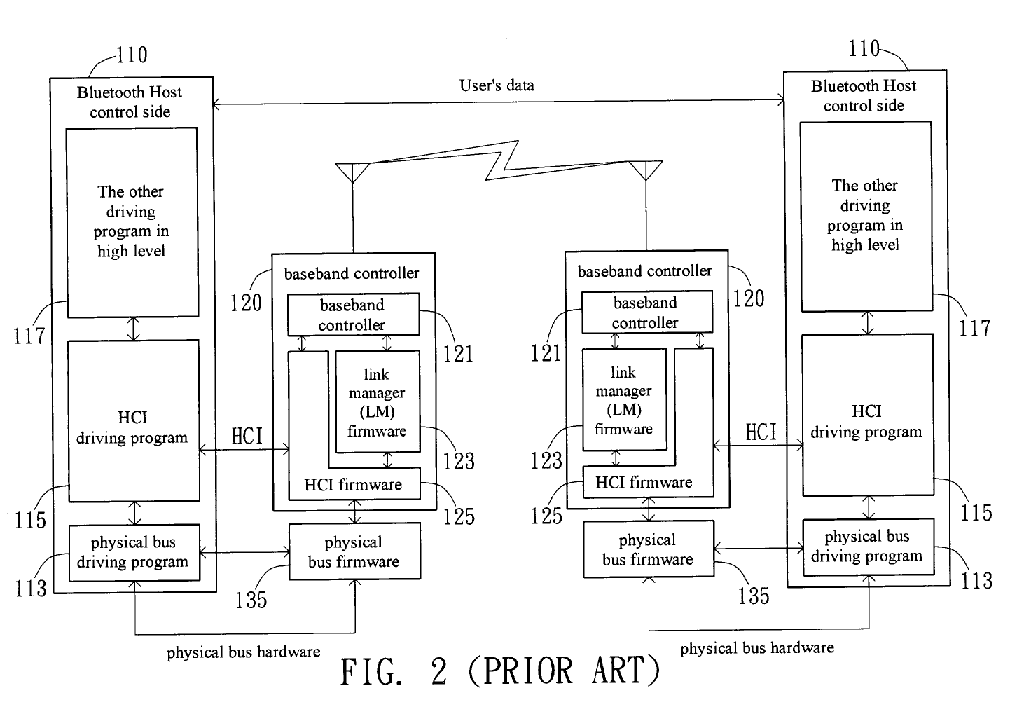

### DETAILED DESCRIPTION OF PREFERRED EMBODIMENTS

The present invention provides an external connection apparatus with the Bluetooth function capable of multiple operation modes. This kind of external connection apparatus can be an extension card, such as a Personal Computer Memory Card International Association (PCMCIA) card, a compact flash (CF) card, a universal serial bus (USB) card, or an IEEE 1394 card, and so on. The external connection apparatus with the Bluetooth function in multiple operation modes can support at least two different data transmission interfaces, such as the HCI interface or the universal asynchronous receiver/transmitter (UART) interface. Taking the notebook computer as an example in application, if the computer does not include the Bluetooth driving program, the extension card can be plugged in, and the data can be transmitted via the UART interface. Since the UART interface is the most basic transmitting interface, that is the common sharing port (COM port), it is surely supported by the operation system in the notebook computer system. On the contrary, if the computer system is already installed with the Bluetooth driving program, it would be certain that the data could be transmitted via the HCI interface of the extension card.

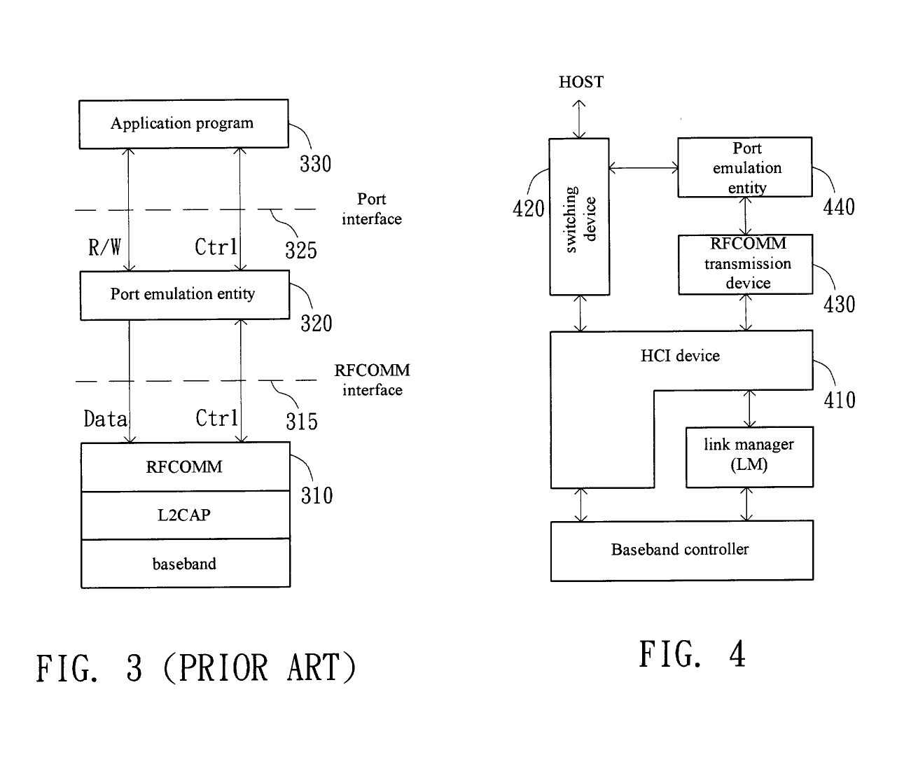

Referring to FIG. 3, it is a drawing, schematically illustrating the situation for the RFCOMM in the Bluetooth system to emulate the serial port of RS232. The RFCOOM transmission device 310 can use the port emulation entity 320 to transmit the data to the host side to be processed by the application programs 330. These kinds of application programs 330 can be, for example, the programs of computer in direct connection or the terminal, attached to the operation system for the Window. The RFCOMM transmission device 310 can use the RFCOMM interface 315 and the port emulation entity 320 for transmitting the data. The control signal (Ctrl) between the two elements can be used to set the usual control parameters and the port parameters. On the other hand, the port emulation entity 320 can perform the reading and writing functions and the control for the data by using the port interface 325 and the application programs 330, wherein the port interface 325 is a virtual common port (VCOMM), for example.

Referring to FIG. 4, it is a block diagram, schematically illustrating an external connection apparatus with the Bluetooth function with multiple operation modes, according to one embodiment of the present invention. If the host side has the Bluetooth driving program, the host controller interface (HCI) device 410 can pack up all of the received digital data into an HCI packet and export the packet to the host side by the switching device 420. Then, the Bluetooth driving program at the host side can be executed to process the subsequent data. On the other hand, if the host side has not been installed with the Bluetooth driving program, then the host controller interface 410 will first feed the HCI packet to the RFCOMM transmission device 430 and use the RFCOMM transmission device 430 to convert the HCI packet into the format used by the common sharing port, and then transmit the converted data packet to the port emulation entity 440. Afterward, the port emulation entity 440 can export the data string of the data packet to the switching device 420, which then transmits the information to the host side to be processed. It should be noted that the switching device 420 can automatically switch to the proper data transmission manner, according to whether or not the host side has the Bluetooth driving program. Thus, once the external connection apparatus with the Bluetooth function is connected, all of the data can be processed for transmitting data in the wireless way, whether or not the host side has the Bluetooth driving program.

It is worth noting that even though the features of the present invention have been described by taking the preferred embodiment as an example, the disclosed external connection apparatus with the Bluetooth function in multiple operation modes of the present invention is not limited for use in the notebook computer system only. The present invention can also be suitable for use in a desk computer system, a personal digital assistant (PDA), a web pad, and so on. Once a proper connection port can be supplied, such as the connection ports of PCMCIA, CF, USB, IEEE 1394, and so on, it the can be plugged with the present invention of an external connection apparatus with the Bluetooth function in multiple operation modes.

In accordance with the foregoing disclosure of the external connection apparatus with the Bluetooth function in multiple operation modes of the present invention, the wireless data transmission with the Bluetooth function can always be used by the user, whether or not the use has installed the Bluetooth driving program. The present invention provides for the user more convenience in operation.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An external connection apparatus with a Bluetooth function in multiple operation modes, used to provide for a data processing device with a capability of Bluetooth communication, the external connection apparatus with the Bluetooth function in the multiple operation modes comprising:
a host controller interface (HCI) device, used to encode a digital data into a HCI packet;
a RFCOMM transmission device, coupled to the host controller interface device, and used to receive and decode the HCI packet;
a port emulation entity, coupled to the RFCOMM transmission device, and used to receive a decoded HCI packet, which is the HCI packet having been decoded, and export the decoded HCI packet; and
a switching device, coupled to the host controller interface device and the port emulation entity, and used to export one data selected from the group consisting of the HCI packet and the decoded HCI packet exported by the port emulation entity.

2. The external connection apparatus with the Bluetooth function in the multiple operation modes as recited in claim 1, comprising an extension card.

3. The external connection apparatus with the Bluetooth function in the multiple operation modes as recited in claim 2, wherein the data processing device at least comprises one selected from the group consisting of a notebook computer, a desk computer system, a personal digital assistant (PDA), and a web pad.

4. The external connection apparatus with the Bluetooth function in the multiple operation modes as recited in claim 1, wherein the data processing device comprises a data processing device that is not installed with a Bluetooth driving program.

5. The external connection apparatus with the Bluetooth function in the multiple operation modes as recited in claim 2, wherein the extension card comprises a PCMCIA card.

6. The external connection apparatus with the Bluetooth function in the multiple operation modes as recited in claim 2, wherein the extension card comprises a CF card.

7. The external connection apparatus with the Bluetooth function in the multiple operation modes as recited in claim 2, wherein the extension card comprises a USB card.

8. An external connection apparatus with a Bluetooth function in multiple operation modes, used to provide for a data processing device with a capability of Bluetooth communication, the characteristics of the external connection apparatus with the Bluetooth function in the multiple operation modes comprising:
a switching device, wherein the switching device switch to a proper one of a data transmission mode for transmitting data, according to whether or not the data processing device has been installed with a Bluetooth driving program.

9. The external connection apparatus with the Bluetooth function in the multiple operation modes as recited in claim 8, comprising an extension card.

10. The external connection apparatus with the Bluetooth function in the multiple operation modes as recited in claim 9, wherein the data processing device at least comprises one selected from the group consisting of a notebook computer, a desk computer system, a personal digital assistant (PDA), and a web pad.

11. The external connection apparatus with the Bluetooth function in the multiple operation modes as recited in claim 8, wherein the data processing device comprises a data processing device that is not installed with a Bluetooth driving program.

12. The external connection apparatus with the Bluetooth function in the multiple operation modes as recited in claim 9, wherein the extension card comprises a PCMCIA card.

13. The external connection apparatus with the Bluetooth function in the multiple operation modes as recited in claim 9, wherein the extension card comprises a CF card.

14. The external connection apparatus with the Bluetooth function in the multiple operation modes as recited in claim 9, wherein the extension card comprises a USB card.
